(19) United States
(12) Patent Application Publication
(10) Pub. No.: US 2010/0330228 A1
(43) Pub. Date: Dec. 30, 2010

(54) SOUP OR SAUCE COMPOSITION

(76) Inventors: Ellen Maria Elizabeth Mulder, AZ Wormerveer (NL); Miriam Aldegonda Josephina Van Wanroij, AZ Wormerveer (NL); Jeroen Monster, AZ Wormerveer (NL); Ulrike Schmid, AZ Wormerveer (NL)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/740,200

(22) PCT Filed: Oct. 22, 2008
(86) PCT No.: PCT/EP2008/008916

§ 371 Date: Aug. 6, 2010

(30) Foreign Application Priority Data
Oct. 29, 2007 (EP) 07254270.7

(51) Int. Cl. A23K 1/18; A23L 1/40; A23L 1/302

(52) U.S. Cl. 426/2; 426/589; 426/72

(57) ABSTRACT

A soup or sauce comprising: water; one or more components selected from meat ingredients, vegetable ingredients and carbohydrates; and from 0.5% to 20% by weight added fat, wherein said fat comprises at least 90% by weight conjugated linoleic acid.

This invention relates to a soup or sauce composition and to a process for its production.

The nutritional value of the diet has come under increasing scrutiny. Food supplements are often taken by individuals in order to obtain nutritional benefits. However, food supplements are typically in the form of capsules or the like and have the disadvantage that they are inconvenient in that an individual has to remember to take them. Food supplements of this type are typically not flavoured and are not attractive to many consumers.

Nutritional supplements have been incorporated into food products but the resulting food products can have an undesirable taste and the incorporation of the supplement can have a deleterious effect on the stability of the products.

Conjugated linoleic acid (CLA) is a conjugated dienoic fatty acid having 18 carbon atoms. As a result of the presence of the two double bonds in CLA, geometrical isomerism is possible and the CLA molecule or moiety may exist in a number of isomeric forms. The cis9, trans11 (“c9t11”) and trans10, cis12 (“t10c12”) isomers of CLA are generally the most abundant and beneficial pharmacological effects have been identified for each of these isomers.

EP 1618800 discloses a tomato ketchup composition comprising 0.5 parts per hundred of conjugated linoleic acid.

U.S. Pat. No. 5,370,896 discloses a sauce or soup comprising from 2% to 10% by weight of fat droplets as an emulsion in an aqueous base.

U.S. Pat. No. 4,840,806 discloses a tomato sauce comprising soybean oil.

There remains a need for food products that contain nutritional supplements, particularly those that confer one or more benefits on the food product.

Soup is a liquid food that is made by combining ingredients. Soups are classified into two broad groups: clear soups and thick soups. An instant soup is a soup to which hot water is added directly before use. Typical examples of soups are tomato soup, mushroom soup, asparagus soup, leek soup, onion soup, chicken soup and noodle soup.

In cooking, a sauce is liquid or sometimes semi-solid food served on or used in preparing other foods. Examples of sauces are white sauces (mushroom sauce), brown sauces, emulsified sauces (bearnaise sauce, hollandaise sauce), butter sauces, East Asian sauces (soy sauce), béchamel sauces, and tomato sauce.

According to the present invention there is provided a soup or sauce comprising: water; one or more components selected from meat ingredients, vegetable ingredients and carbohydrates; and from 0.5% to 20% by weight added fat, wherein said fat comprises at least 90% by weight conjugated linoleic acid.

In another aspect, the invention provides a composition which, upon rehydration with water, forms a soup or sauce according to the invention.

A further aspect of the invention is the use of a soup or sauce composition according to the invention for a nutritional benefit.

It has been found that a convenient vehicle for the consumption of conjugated linoleic acid and its derivatives can be provided by certain soups and sauces. Surprisingly, it is possible to incorporate the conjugated linoleic acid or derivative in soups and sauces in relatively high amounts and yet still achieve good oxidative stability compared to other, less unsaturated oils or oils having the same amount of unsaturation. The soups and sauces may also have good organoleptic properties (including taste and texture) and good stability. Additionally, it is possible for the soups and sauces to have a low calorie content and still achieve these advantages. The invention achieves these benefits in a soup or sauce in which the added fat has a relatively high content of CLA.

The soup or sauce of the invention comprises one or more components selected from meat and vegetable ingredients and carbohydrates. Suitable meats include, for example, beef, chicken, lamb and pork (such as ham), and the term “meat” in this context also includes fish and shellfish. The term “vegetable” is used in a culinary sense and includes any parts of an edible plant or fungus. Suitable vegetables include, for example, tomato, carrot, leek, onion, mushroom, pea, pumpkin, potato, cucumber, mint, asparagus, bean, lentil, chickpea, spices (such as nutmeg and pepper) and mixtures thereof. Meat and vegetables are in a form that is suitable for incorporation into soups and sauces, such as in dried and/or comminuted forms, as will be well-known to those skilled in the art. The soups and sauces may contain one or more vegetable ingredients and/or one or more meat ingredients.

Carbohydrates may be used singly or as a mixture of two or more carbohydrates. Preferred carbohydrates for use in the soup or sauce of the invention include sucrose, starch, modified starch, xanthan and mixtures thereof. At least part of the carbohydrate may be provided by flour.

The soup or sauce of the invention comprises from 0.5% to 20% by weight added fat, more preferably from 0.6 to 19%, such as from 0.7 to 18%, more preferably from 0.9 to 15%, even more preferably from 1 to 10%, such as from 1.5 to 5% by weight added fat. The fat comprises at least 90% by weight, such as at least 91% or at least 92% or at least 93% by weight, of conjugated linoleic acid, based on the total fatty acids (i.e., C12 to C24 carboxylic acids) present in the fat. Typically, the conjugated linoleic acid will be present in the fat in the form of a glyceride, such as a triglyceride. The term “added fat” refers to fat that does not form part of any vegetable and/or meat ingredients or the carbohydrate or any other components of the soup or sauce.

Preferably, the soup or sauce of the invention comprises from 1% to 10% by weight carbohydrates and from 0.5% to 10% by weight protein.

Sources of protein for the soups and sauces of the invention are preferably selected from the group consisting of whey solids, skimmed milk powder, soya protein, low fat yoghurt, skimmed milk and mixtures thereof.

The soup or sauce may comprise an added fat A and a further fat B, wherein fat A comprises at least 90% by weight conjugated linoleic acid and fat B is selected from the group consisting of: dairy fats (such as butter, cream and sour cream); cocoa butter equivalents, cocoa butter, palm oil or fractions thereof, palm kernel oil or fractions thereof, interesterified mixtures of above fats or fractions or hardened components thereof; liquid oils, such as sunflower oil, high oleic sunflower oil, soybean oil, rapeseed oil, cottonseed oil, safflower oil, high oleic safflower oil, olive oil, flaxseed oil, maize oil or MCT oils; and mixtures thereof. Fat B does not form part of the “added fat” as defined herein. Fat A may be mixed with fat B prior to addition to the soup or sauce or fat A and fat B can be included separately. Typically, the weight ratio of fat A to fat B is from 100:1 to 1:10, more preferably from 10:1 to 1:2, such as from 5:1 to 1:1.

Examples of fatty acids that may be present in the fat B, in addition to or separate from other saturated and unsaturated fatty acids, include linoleic acid, oleic acid, arachidonic acid, taxoleic, juniperonic, sciadonic, pinolenic acid, conjugated linoleic acid, an enriched isomer mixture of conjugated linoleic acid, EPA (eicosapentaenoic) and DHA (docosahexaenoic). These fatty acids will usually be present in the form of glycerides.

Preferably, the soup or sauce comprises from 0.5 to 10% by weight of protein. The protein can be added as such in a relatively concentrated from (e.g., having a protein content of greater than 70% by weight) or may form part of another material that is included in the composition, such as milk or yoghurt, for example.

Preferably, the protein is selected from the group consisting of whey solids, skimmed milk powder and soya protein, cream, sour cream, low fat yoghurt, skimmed milk and mixtures thereof.

Soups or sauces of the invention preferably comprise at least 60% by weight of water, more preferably at least 70% by weight water, even more preferably from 80 to 95% by weight water. Water can be included as relatively pure water or as part of another material such as, for example, milk or yoghurt.

The soups and sauces preferably contain carbohydrates. Carbohydrates have the general formula CₙH₂ₙOₙ and are divided in three main groups: monosaccharides, disaccharides and polysaccharides. Examples of suitable monosaccharides include glucose, galactose, and fructose. Suitable disaccharides can be sucrose, lactose and maltose. Examples of polysaccharides often referred to as fibers or used as thickeners include starch, cellulose, pectin, glycogen, xanthan, gum acacia, modified food starches (e.g., alkenylsuccinate modified food starches), anionic polymers derived from cellulose (e.g. carboxymethylcellulose), gum ghatti, modified gum ghatti, xanthan gum, tragacanth gum, guar gum, locust bean gum, pectin, gelatine, carrageenan and mixtures thereof. Preferred carbohydrates for use in the soup or sauce of the invention include sucrose, starch, modified starch, xanthan and mixtures thereof.

Typical amounts of carbohydrates are from 1.0 to 10% by weight of the compositions.

This invention includes a soup or sauce composition comprising on dry basis 3 to 40% added fat, wherein said fat comprises at least 90% by weight CLA, even more preferably from 93 to 99% by weight CLA.

Soups and sauces of the invention may include one or more solids such as meat or vegetable pieces, pasta or noodles.

The soups and sauces of the invention may be formed from a composition of the invention upon rehydration with water. Such compositions are also known as dried or instant soups and sauces. Typically, the water that is used for reconstitution is hot water. The compositions are typically adapted for reconstitution with a volume of water in the range of from 100 ml to 500 ml. Preferably, the composition comprises on dry basis 3 to 40% added fat, wherein said fat comprises at least 90% by weight CLA, even more preferably from 93 to 99% by weight CLA.

It has been found that by combining the sauce or soup components according to the invention and adapting the level of conjugated linoleic acid or derivative in the fat phase, it is possible to obtain a soup or sauce having one or more of: improved taste; stability in that there is little phase separation; no problems with aggregation and/or flocculation of particulate matter; no creaming; good homogeneity; enhanced viscosity; good colour; balanced flavour; little or no aftertaste; and an optimal droplet size distribution. Many or all of these positive effects preferably persist over time e.g., all of the effects remain positive over a period of at least 3 months, preferably about 6 to 12 months. Surprisingly, these positive attributes can be achieved in soups and sauces having relatively low energy contents. This means that it is possible to produce a low calorie product comprising conjugated linoleic acid or a derivative of conjugated linoleic acid.

Moreover, despite the level of unsaturation of conjugated linoleic acid, the soups and sauces have unexpectedly good oxidative stability when compared to other oils, such as high oleic sunflower oil, sunflower oil, fat comprising lower amounts of conjugated fatty acids, such as 80% by weight of conjugated linoleic acid and/or fish oils.

A synergistic nutritional effect may also be present between the fat phase of the soups/sauces and other components in the soups/sauces, for example vegetable puree, extra vitamins. An example of such an effect is an enhancement of body weight management and/or greater reduction of atherosclerosis.

Preferably, the soup or sauce composition of the invention is a low calorie product. For example, the soup or sauce composition may have an energy content of less than 100 kcal/100 g, more preferably less than 80 kcal/100 g, even more preferably from 55 to 75 kcal/100 g. Calorie contents can be determined by methods well known to those skilled in the art, for example, as set out in Mullan, 2006, Labelling Determination of the Energy Content of Food: http://www.dairyscience.info/energy_label.asp#3 and/or FAO Food And Nutrition Paper 77, Food energy—methods of analysis and conversion factors, Report of a Technical Workshop, Rome, 3-6 Dec. 2002, Food And Agriculture Organization of the United Nations, Rome, 2003, ISBN 92-5-105014-7.

Soup or sauce compositions of the invention optionally comprise one or more additional additives selected from flavours, colouring agents, vitamins, minerals, acidity regulators, preservatives, emulsifiers, antioxidants, and mixtures thereof. Each of these materials may be a single component or a mixture of two or more components.

Examples of suitable vitamins and minerals include calcium, iron, zinc, copper, phosphorous, biotin, folic acid, pantothenic acid, iodine, vitamin A, vitamin C, vitamin B1, vitamin B2, vitamin B3, vitamin B6, vitamin B9, vitamin B12, vitamin D, vitamin E, and vitamin K. Preferably, wherein a vitamin or mineral is utilized the vitamin or mineral is selected from iron, zinc, folic acid, iodine, vitamin A, vitamin C, vitamin Be, vitamin B3, vitamin B6, vitamin B12, vitamin D, and vitamin E.

Acidity regulators include organic as well as inorganic edible acids. The acids can be added or be present in their undissociated form or, alternatively, as their respective salts, for example, potassium or sodium hydrogen phosphate, potassium or sodium dihydrogen phosphate salts. The preferred acids are edible organic acids which include citric acid, malic acid, fumaric acid, adipic acid, phosphoric acid, gluconic acid, tartaric acid, ascorbic acid, acetic acid, phosphoric acid, or mixtures thereof. Glucono Delta Lactone (GDL) may also be used, particularly wherein it is desired to reduce pH without introducing excessive acidic, or tart, flavour in the final composition.

Preservatives may be selected from the group consisting of sorbate preservatives, benzoate preservatives, and mixtures thereof.

Antioxidants include, for example, natural or synthetic tocopherols, TBHQ, BHT, BHA, free radical scavengers, propylgallate, ascorbylesters of fatty acids and enzymes with anti-oxidant properties.

The soup or sauces of the invention may be free of dairy material and, for example, may be free of lactose.

The soup or sauce composition may be produced by a process which comprises adding to one or more components selected from water, meat ingredients, vegetable ingredients and carbohydrates, from 0.5% to 20% by weight fat, wherein said fat comprises at least 90% by weight conjugated linoleic acid. Any remaining components are added thereafter.

A preferred process of the invention comprises:
(i) forming an emulsion of the fat in water in the presence of a protein;
(ii) forming a dispersion or solution of a carbohydrate in water;
(iii) optionally adding one or more additional ingredients;
(iv) mixing the compositions prepared in steps (i) and (ii) under shear;
(v) optionally homogenising and/or pasteurizing; and
(vi) optionally cooling.

Conjugated linoleic acid or a derivative of conjugated linoleic acidis an essential component of the compositions of the invention. The conjugated linoleic acid or derivative (which term is intended to cover both conjugated linoleic acid and derivatives when both are present) is preferably in a form selected from the free acid, salts, mono-, di- or triglycerides, or mixtures thereof.

The preferred form of CLA for use in the invention is as a glyceride. Particularly preferred are diglycerides and triglycerides, with triglycerides being even more preferred.

The CLA may comprise one isomer or a mixture of two or more different isomers including: cis, cis; cis, trans; trans, cis; and trans, trans isomers. Preferred isomers are the trans10, cis12 and cis9, trans 11 isomers (also referred to herein as t10c12 and c9t11, respectively), including these isomers in relatively pure form, as well as mixtures with each other and/or mixtures with other isomers. More preferably, the conjugated linoleic acid or derivative thereof comprises trans10, cis12 and cis9, trans11 isomers and the weight ratio of trans10, cis12 isomer to cis9, trans11 isomer or vice versa is at least 1.2:1, such as 1.3:1, even more preferably at least 1.5:1, e.g., in the range 1.5:1 to 100:1 or 1.5:1 to 10:1, such as a 60:40 or 80:20 mixture of the trans10, cis12:cis9, trans 11 isomers. Particularly preferred are compositions comprising the trans10, cis 12 isomer or the cis9, trans 11 isomer as the major isomer component i.e., present in an amount of at least 55%, preferably at least 60%, more preferably at least 70%, even more preferably at least 75%, most preferably at least 80%, such as at least 90% or even 100% by weight based on the total amount of conjugated linoleic acid. For example, the CLA may comprise c9t11 and t10c12 isomers and the weight ratio of the c9t11 to t10c12 isomers may be from 99:1 to 1 to 99, preferably from 90:10 to 10:90 most preferably from 80:20 to 20:80.

CLA can be produced in conventional ways. For example, CLA can be produced by known methods, such as that described in EP-A-902082, the contents of which are incorporated herein by reference. CLA products that are enriched in one or more isomers are disclosed in WO 97/18320, the contents of which are also incorporated herein by reference.

The conjugated linoleic acid or derivative in the soup or sauce compositions may form part of a fat composition that comprises one or more other components. The fat will typically be present in the soup or sauce composition in the form of an emulsion, suspension or dispersion. The fat is generally present homogeneously throughout the aqueous phase of the soup or sauce.

The conjugated linoleic acid or derivative thereof can be included in the soup or sauce of the invention as an oil or in the form of a powder, such as a free flowing powder. Conjugated linoleic acid and its derivatives in powder form can be produced, for example, by spray drying conjugated linoleic acid or its derivatives, or a fat comprising conjugated linoleic acid or its derivatives, with protein and/or carbohydrate, with the powder typically comprising from 50 to 90% of fat. It has been found that use of the powder can give extra stability to the soup or sauce.

The listing or discussion of an apparently prior-published document in this specification should not necessarily be taken as an acknowledgement that the document is part of the state of the art or is common general knowledge.

The following non-limiting examples illustrate the invention and do not limit its scope in any way. In the examples and throughout this specification, all percentages, parts and ratios are by weight unless indicated otherwise.

### EXAMPLES

### Example 1

Tomato soup

| % by weight | Ingredient |
|---|---|
| 52 | Tomato |
| 2 | CLA G-95 |
| 1.5 | Butter |
| 2.7 | Modified starch |
| 3.5 | Sucrose |
| 1 | Skimmed milk powder |
| 0.04 | Basil |
| 0.38 | Salt |
| To 100% | Water |

CLA G-95 (Clarinol™ G-95, Lipid Nutrition BV, Wormerveer, The Netherlands) is an oil high in isomers of Conjugated Linoleic Acid (CLA). The two main isomers present are cis-9, trans-11 (c9,t11) and trans-10, cis-12 (t10,c12) CLA, in a 50:50 ratio. The product is made from safflower oil.

### Technical Characteristics (Typical Values)

| | |
|---|---|
| Free fatty acid as % oleic acid: | 0.7 |
| Peroxide value meq 02/kg: | 0.3 |
| Total CLA %: | 93 |
| c9, t11 + t10, c12 isomers %: | 89 |
| Trans fatty acids %: | 0.8 |
| Total saturated fatty acids %: | 0.5 |

### Example 2

White sauce

| % by weight | Ingredient |
|---|---|
| 3.5 | CLA G-95 |
| 2.5 | Modified starch |
| 2.5 | Flour |
| 3.5 | Sucrose |
| 0.3 | Xanthan |
| 4.6 | Milk protein |
| 0.04 | Nutmeg |
| 0.38 | Salt |
| To 100% | Water |

1. A soup or sauce comprising: water; one or more components selected from meat ingredients, vegetable ingredients and carbohydrates; and from 0.5% to 20% by weight added fat, wherein said fat comprises at least 90% by weight conjugated linoleic acid.

2. A soup or sauce as claimed in claim 1 comprising from 1% to 10% by weight carbohydrates and from 0.5% to 10% by weight protein.

3. A soup or sauce as claimed in claim 1, comprising carbohydrates selected from the group consisting of sucrose, starch, modified starch, xanthan and mixtures thereof.

4. A soup or sauce of claim 1, which comprises one or more sources of protein selected from the group consisting of whey solids, skimmed milk powder, soya protein, low fat yoghurt, skimmed milk and mixtures thereof.

5. A soup or sauce of claim 1 comprising at least 60% by weight of water.

6. A soup or sauce of claim 1 comprising at least 70% by weight water.

7. A soup or sauce of claim 1, comprising an added fat A and a further fat B, wherein fat A comprises at least 90% by weight conjugated linoleic acid and fat B is selected from the group consisting of: dairy fats; cocoa butter equivalents, cocoa butter, palm oil or fractions thereof, palm kernel oil or fractions thereof, interesterified mixtures of above fats or fractions or hardened components thereof; liquid oils; and mixtures thereof.

8. A soup or sauce of claim 1 which has an energy content of less than 100 kcal/100 g.

9. A soup or sauce of claim 1 which has an energy content of less than 80 kcal/100 g.

10. A soup or sauce of claim 1 which has an energy content of from 55 to 75 kcal/100 g.

11. A soup or sauce of claim 1 comprising one or more additives selected from flavours, colouring agents, vitamins, acidity regulators, preservatives, emulsifiers, antioxidants, dietary fibres and mixtures thereof.

12. A soup or sauce of claim 1, wherein at least a portion of the added fat is incorporated in the soup or sauce in the form of a powder.

13. A soup or sauce as claimed in claim 12, wherein the powder is produced by spray drying a fat comprising conjugated linoleic acid with protein and/or carbohydrate.

14. A composition which, upon rehydration with water, forms a soup or sauce according to claim 1.

15. A process for producing a soup or sauce comprising: adding to one or more components selected from water, meat ingredients, vegetable ingredients and carbohydrates, from 0.5% to 20% by weight fat, wherein said fat comprises at least 90% by weight conjugated linoleic acid.

16. A process for producing a soup or sauce composition, comprising:
(i) forming an emulsion of the fat in water in the presence of a protein;
(ii) forming a dispersion or solution of a carbohydrate in water;
(iii) optionally adding one or more additional ingredients;
(iv) mixing the compositions prepared in steps (i) and (ii) under shear;
(v) optionally homogenising and/or pasteurizing; and
(vi) optionally cooling.

17. (canceled)

18. (canceled)

19. A soup or sauce or claim 6 comprising 80 to 95% by weight water.

20. A soup or sauce of claim 7 wherein the dairy fat is butter, cream or sour cream.

21. A soup or sauce of claim 7 wherein the liquid oil is sunflower oil, high oleic sunflower oil, soybean oil, rapeseed oil, cottonseed oil, safflower oil, high oleic safflower oil, olive oil, flaxseed oil, maize oil or MCT oil.

22. A method for providing a nutritional benefit comprising consuming a soup or a sauce of claim 1.
